(19) United States
(12) Patent Application Publication
(10) Pub. No.: US 2026/0260410 A1
(43) Pub. Date: Sep. 3, 2026

(54) SYSTEM AND METHOD FOR COMBINING AND CONTROLLING OF EXPRESSIVE ANIMATED FACIAL BEHAVIOR

(71) Applicant: JALI INC., Toronto (CA)

(72) Inventors: Pif EDWARDS, Toronto (CA); Chris LANDRETH, Toronto (CA); Karan SINGH, Toronto (CA); Jacob RITCHIE, Toronto (CA)

(21) Appl. No.: 19/066,907

(22) Filed: Feb. 28, 2025

(51) Int. Cl. G06T 13/40

(52) U.S. Cl. CPC G06T 13/40

(57) ABSTRACT

There is provided a method, system, and user interface for combining expressive facial behavior for an animated character. The method includes receiving two or more expressions to be expressed on the animated character, the expressions comprise activation values for one or more facial parameters on the animated character and temporal keyframes for such activation values, at least two of the two or more expressions overlap for a given period of time; assigning each of the two or more expressions to a respective channel, one of such channels being designated as dominant; combining the activation values of the expressions from the two or more channels for each of the one or more facial parameters, the expression in the dominant channel designating the temporal keyframes when the activation values of the two or more expressions are combined; and outputting the combined activation values for animation of the animated character.

### TECHNICAL FIELD

The following relates generally to user interfaces and computer animation, and more specifically, to a system, method, and user interface for combining and controlling of expressive animated facial behavior.

### BACKGROUND

There is a strong interest in digital avatars and three-dimensional (3D) facial animation, which illustrates the need for representations and synthesis of all forms of expressive facial communication. Humans extract considerable meaning from facial expressions and body language. These behaviors corelate to a varying degree to any accompanying dialogue: the lips of a speaking animated character typically corelate strongly to speech, such as the lips closing when enunciating a phonetic ‘m’ sound. In other cases, for example, eye blinks and brow motion, while not required for producing sound in speech, often corelate to pauses and emphasis in spoken dialogue. Such non-verbal activity that arises in response to linguistic activity can be referred to as paralingual behavior. Even the facial expressions of a listening character in a dialogue corelate to aspects and timing of what they are hearing, such a head nod to express agreement, or an expressive emotional response to what they hear. While an animated character can appear, for example, tense, angry, or bored, even when no surrounding dialogue is present, facial expressions conveying emotion can still play an essential part of speech in human communication. The faces of computer animated 3D characters are typically controlled by a configuration of activation values for a set of facial parameters, referred to herein as ‘action units’. Faces are computer animated by outputting animation curves (or activation values, or activations) for a set of action units over time.

### SUMMARY

In an aspect, there is provided a method of combining expressive facial behavior for an animated character, the method executed on a processing unit, the method comprising: receiving two or more expressions to be expressed on the animated character, the expressions comprise activation values for one or more facial parameters on the animated character and temporal keyframes for such activation values, at least two of the two or more expressions overlap for a given period of time; assigning each of the two or more expressions to a respective channel, one of such channels being designated as dominant; combining the activation values of the expressions from the two or more channels for each of the one or more facial parameters, the expression in the dominant channel designating the temporal keyframes when the activation values of the two or more expressions are combined; and outputting the combined activation values for animation of the animated character.

In a particular case of the method, each received expression is associated with a received duration for such expression, and wherein at least a portion of the duration of two of the expressions overlap in time.

In another case of the method, the expressions are aligned with a transcript or audio, and wherein at least a portion of the overlap is for the duration of a phoneme or sub-phoneme in the transcript or audio.

In yet another case of the method, the activation values of the one or more channels that are not dominant are residual activation values, the residual activation values are constant for a given temporal duration.

In yet another case of the method, the activation values from the channels are combined using one of maximum, minimum, average, sum, sum-max, and max-blend operators.

In yet another case of the method, the activation values are combined using a maximum function whereby the activation values from one of the non-dominant channels is expressed when greater than the activation value of the dominant channel.

In yet another case of the method, the method further comprising constraining the combined activation values at a particular facial parameter to a threshold value.

In yet another case of the method, constraining the combined activation values is based on constraining facial parameter shapes for producing speech.

In yet another case of the method, the two or more expressions are received from a user interface that can receive selections from the user, the user interface presents a gallery of expressions to the user with a range of intensity values.

In yet another case of the method, symmetrical action units on both sides of the face are constrained to be activated similarly.

In another aspect, there is provided a system for combining expressive facial behavior for an animated character, the system comprising a processing unit and a data storage, the data storage comprising instructions for the processing unit to execute: an input module to receive two or more expressions to be expressed on the animated character, the expressions comprise activation values for one or more facial parameters on the animated character and temporal keyframes for such activation values, at least two of the two or more expressions overlap for a given period of time; an expression module to assign each of the two or more expressions to a respective channel, one of such channels being designated as dominant; an activation module to combine the activation values of the expressions from the two or more channels for each of the one or more facial parameters, the expression in the dominant channel designating the temporal keyframes when the activation values of the two or more expressions are combined; and an output module to output the combined activation values for animation of the animated character.

In a particular case of the system, each received expression is associated with a received duration for such expression, and wherein at least a portion of the duration of two of the expressions overlap in time.

In another case of the system, the expressions are aligned with a transcript or audio, and wherein at least a portion of the overlap is for the duration of a phoneme or sub-phoneme in the transcript or audio.

In yet another case of the system, the activation values of the one or more channels that are not dominant are residual activation values, the residual activation values are constant for a given temporal duration.

In yet another case of the system, the activation values from the channels are combined using one of maximum, minimum, average, sum, sum-max, and max-blend operators.

In yet another case of the system, the activation values are combined using a maximum function whereby the activation values from one of the non-dominant channels is expressed when greater than the activation value of the dominant channel.

In yet another case of the system, the processing unit further executes a constraint module to constrain the combined activation values at a particular facial parameter to a threshold value.

In yet another case of the system, constraining the combined activation values is based on constraining facial parameter shapes for producing speech.

In yet another case of the system, the two or more expressions are received from a user interface that can receive selections from the user, the user interface presents a gallery of expressions to the user with a range of intensity values.

In yet another case of the system, the processing unit further executes a constraint module to constrain symmetrical action units on both sides of the face to be activated similarly. These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram of a system for combining and controlling expressive facial behavior for an animated character;

FIG. 2 is a flowchart of a method for combining and controlling expressive facial behavior for an animated character;

FIG. 3 illustrates an example of expression pose activation values on a control board for different intensity values, in accordance with an embodiment of the system of FIG. 1;

FIG. 4 illustrates an input text and .wav file pair, in order to show how the output deformation on the character rig is affected by two different independent inputs that could be provided for the mask expression channel, in accordance with an embodiment of the system of FIG. 1;

FIG. 5 illustrates an example tagging interface and expression browser, as part of the user interface of the system of FIG. 1;

FIGS. 6 and 7 show two example views of the expression browser of the user interface showing many possible mask emotion bearings on two respective output character rigs, in accordance with an embodiment of the system of FIG. 1;

FIG. 8 shows an example screenshot of an approach for expression browser and timeline interface, in accordance with an embodiment of the system of FIG. 1;

FIG. 9 shows an example of adding a tag via user input using an expression browser and timeline, in accordance with an embodiment of the system of FIG. 1;

FIG. 10 shows an example of editing a section of text transcript that a tag applies to via user input, in accordance with an embodiment of the system of FIG. 1;

FIG. 11 illustrates an example of activation values of an action unit for a case where there are overlapping heart and mask expressions, in accordance with an embodiment of the system of FIG. 1;

FIG. 12 illustrates an example of combining a mask channel expression and heart channel expression that overlap in time but do not overlap in space, in accordance with an embodiment of the system of FIG. 1;

FIG. 13 illustrates an example of output character rig deformations showing the effect of constraints that prevent unrealistic face configurations when combining speech and expression curves, in accordance with an embodiment of the system of FIG. 1;

FIG. 14 shows example output character rig deformations showing the effect of a lip stick constraint, in accordance with an embodiment of the system of FIG. 1;

FIG. 15 illustrates an example of a non-static expression, in accordance with an embodiment of the system of FIG. 1;

FIG. 16 illustrates a form of an expression browser of the user interface where the expressions are sorted by valence and arousal around the currently selected expression, in accordance with an embodiment of the system of FIG. 1;

FIG. 17 illustrates a realistic example of input and output of additive balancing on a smile action unit, in accordance with an embodiment of the system of FIG. 1; and

FIG. 18 illustrates an example of animation curves, in accordance with the system of FIG. 1.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to user interfaces and computer animation, and more specifically, to a system, method, and user interface for combining and controlling of expressive animated facial behavior.

The present inventors have advantageously determined that for greater realism of animated characters, facial expressions can be considered multi-layered because expressions typically carry a mix of a character's involuntary emotional state and emotions the character would like to voluntarily convey. Additionally, facial expressions can also include anatomical maintenance actions; such as licking lips, blinks, twitches, and the like. Such facial expressions can be pre-composed into comprehensive expressions, but this can lead to an exponential increase in the number of composed expressions. Advantageously, the different parts of the composed expressions of the present embodiments can vary in their temporal alignment and can also adapt their composition contextually to the input dialogue.

Non-limiting examples of situations where multi-layered expressions would be appropriate are:
putting on a brave face, while dealing with a personal tragedy;
trying to hide excitement with a nonchalant expression;
a faking happiness, characterized by a broad smile, but wide-open eyes; and a seething anger, signified by a calm vocal demeanor, but severe staring eyes.

In real-life performances undertaken by actors, such as for theater and film, in communication with a director, actors typically go through multiple takes to iteratively explore and refine their facial expressions. The ability for a user to similarly explore, control, and refine the performance of computer animated characters from given speech dialogue is a substantial challenge in the art that is advantageously overcome using the present embodiments. The user can effectively act like a director to explore directives for superficial and deep emotions, and the like.

In prior approaches, facial animation of computer animated three-dimensional (3D) characters are generally automatically generated by software from audio and video, video only, or audio only; such as via an interactive computer animation interface. Generally, automatic animation generation software uses a mapping of facial landmarks from input video to drive corresponding facial motion on the digitally represented face geometry of a 3D character. Automatic generation from input audio generally uses a mapping from phonetic sounds, called phonemes, in speech audio input to corresponding mouth shapes, called visemes, that drive the motion of the digitally represented face geometry of a 3D character. Certain techniques can be used to take a corpora of captured dialogue, video, and/or 3D data of human performance as training data for a model to automatically construct mappings from audio and/or video speech input to the facial geometry of 3D animated characters, both speakers and listeners in conversations.

A substantial problem of techniques for automatically animating 3D character faces is directorial control over the resulting animation. The output animation of most automatically generated techniques are uneditable and/or require the output to be regenerated from a recording of an input audio-visual performance, without ability to effectively control the animation output. In prior approaches, some automatic techniques provide control that is too high-level from a directorial perspective; such as providing an audio-visual clip as a stylistic example of the desired output animation, or providing simplistic emotional directives such as ‘happy’ or ‘sad’ to modify the output animation.

A further substantial problem with most prior approaches that use automatic animation techniques is that they are difficult to refine partially, in a spatio-temporal manner. For example, a director may be satisfied with the animated output of a character's lower face, speaking with a smile, but may wish, to spatially alter the behavior of the brows and upper face, to convey a more complex emotion of worry. Or, the director may wish to temporally alter the behavior and intensity of a character's blinking to convey a false sense of confidence. Expression refinement is a non-trivial problem as it must provide a user with enough control to precisely alter the expression of a character's face, while remaining realistic and credible to an input audio performance. As an example, it is difficult to portray a persistent open-mouthed grin while enunciating the word ‘home’, where the enunciating the phoneme ‘o’ typically requires puckering of the lips and enunciating the phoneme ‘m’ requires the lips to close.

In other approaches to expressive 3D animation of characters, interactive keyframing interfaces provide a high degree of control over facial nuance, but require significant user education and expertise, and are labor intensive even when operated by professional animators. In contrast, data-driven techniques that use corpora of 3D credible animated faces to constrain user manipulated faces to remain credible have low user interaction and is not akin to directorial control of human performance.

The present embodiments advantageously provide a user interface that provides directorial-type control over expressions of animated characters in order to explore, edit, and refine the expressive behavior of automatically generated 3D facial animation from speech audio and/or video input.

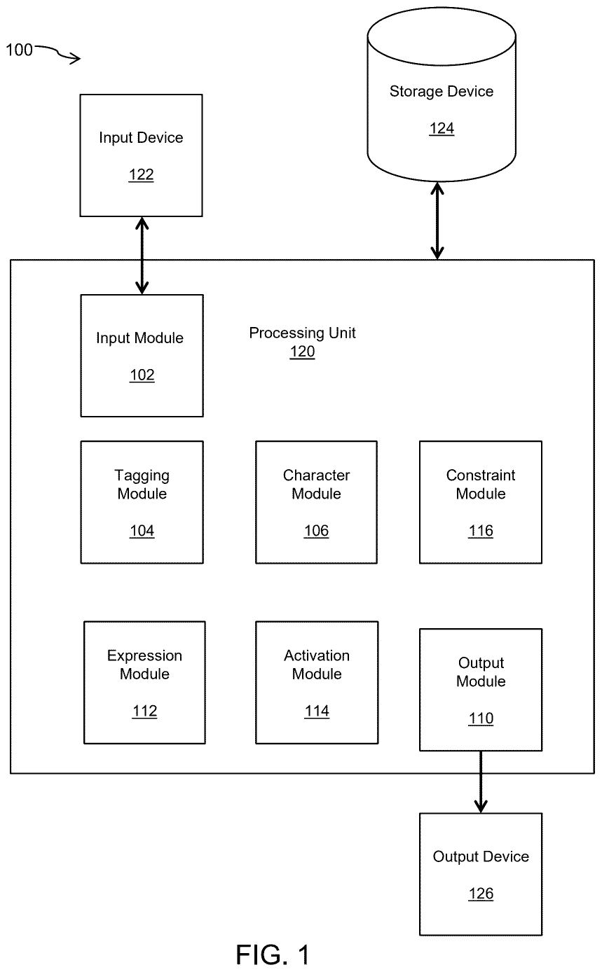

Turning to FIG. 1, a diagram of a system 100 for combining and controlling of expressive animated facial behavior, in accordance with an embodiment, is shown. The system 100 includes a processing unit 120, a storage device 124, an input device 122, and an output device 126. The processing unit 120 includes various interconnected elements and conceptual modules, including an input module 102, a tagging module 104, a character module 106, an output module 110, an expression module 112, an activation module 114, and a constraint module 116. The processing unit 120 may be communicatively linked to the storage device 124 which may be loaded with data, for example, input data, phoneme data, animation data, audio data, video data, or the like. In further embodiments, the above modules may be executed on two or more processors, may be executed on the input device 122 or output device 126, or may be combined in various combinations.

In some cases, the visual appearance of the animated character can be defined digitally using a polygon mesh, i.e. a discrete set of points connected by geometric elements such as polygons. Other examples of geometric representation include parametric surfaces, subdivision surfaces, or implicit surfaces. This geometry can be animated by prescribing the motion of individual geometry points over time, or by functionally relating the motions of these points to a set of high-level parameters, sometimes referred to as a ‘character rig’. A character rig for faces can include a set of target shapes defining various facial expressions, whose point positions are linearly combined using a set of blend shape weights. In other words, a character rig can be thought of as a function f that deforms a set of points P=[p₁ p₂ . . . pₘ] (which can be arranged in a matrix of points) on the character geometry. The points on the character geometry can represent facial skin, hair, and other parts of the face (e.g., tongue and teeth), and/or invisible anatomy (e.g., skull or jawbone). The points P are deformed for a set of n rig parameters W=[w₁, . . . , wₙ] (arranged as a vector). In the case of blend shapes, that often capture facial expression targets from the FACS (facial action coding system), corresponding to each ‘activation level’ or weight wᵢ is an ‘action unit’ or target shape Tᵢ=[t₁ t₂ . . . tₘ] (which can be arranged in a matrix) with target geometric points tᵢ corresponding to the undeformed character point pⱼ. For the points in matrix form, then f (P,W)=P+Σᵢ₌₁ⁿ wᵢ*(Tᵢ−P). Blend shape deformations, as described herein, are but one way of deforming the face. Another example uses weighted combinations of virtual joint positions and rotations to ‘skin’ and deform the face geometry. In all such cases, this present embodiments only require that there is a deformation function f(P,W) that is able to is used to produce facial expressions on facial geometry P, given a configuration of facial parameters, that is the activation values of a set of action units W.

The character representation can have any suitable number of parameters, each of which can be functionally defined using various parameters; for example, a viseme shape parameter might be defined as a functional combination of a set of FACS weighted expressions. Static expressions of the face or body can be produced by activating some subset of the rig parameter set W and expressions of the face or body can be animated as animation curves that define a value over time of those parameters. Note that not all facial parameters that functionally deform the face need be represented as blend-shapes. A common example of such a parameter is the jaw rotation, where the face geometry is deformed as a weighted transformation of bone angles and position of a virtual jaw.

In some cases, facial expression behavior can include both a facial motion clip and/or a static facial expression. A facial motion clip can be considered a set of animation curves that activate all or a subset of the facial rig parameter action units of the face, where the state of such parameters at the beginning and end of the facial motion is substantially the same. As an example, a motion for a blinking expression would activate a parameter that would animate an eye from its current open state to one that was closed and back to an open state. The open state before and after the blink is preferably the same but could be slightly more or less open than the prior state to appear less ‘robotic’. Additionally, a facial expression motion can be parameterized such that it captures a range of timing and visual behavior of the expressive action. For example, animation parameters can modulate the amplitude of a brow raise, its onset timing, or apex value. A single static expression can typically be used as visually representative, for example, as a thumbnail rendering of a facial motion clip.

In some cases, static facial expressions can be manifested in animation as animation curves for the parameters that take the character geometry, or a part of it, from a current state to the desired facial expression. Then, after holding the expression for a period of time, the face can be animated back to its state before the facial expression took place. Static facial expressions can be used to capture a variety of emotional and idiosyncratic behavior; for example, a persistent smile, sneer, pout, eye squint, or brow furrow. However, a single static facial expression may not be able to define more complex motions; for example, back and forth tongue motion of lip licking, or a quivering lip pucker. Single static facial expressions are also often inadequate to capture the varying dynamics of complex emotions; for example, crying when happy, or putting on a brave face to hide sadness.

In an example, each facial expression F in the user interface can be represented by a thumbnail rendering of the facial parameters W of the expression applied to the face of a 3D animated character.

The facial expressions in the user interface can be sourced from one or more suitable sources. In an example, the facial expressions can be interactively created by animators directly adjusting the numerical values of the face parameters. In another example, given textual descriptions of facial expression, the facial expressions can be generated automatically from models trained on a data corpus of facial expressions. In another example, facial expressions can be loaded from libraries of previously catalogues facial expression. In yet another example, the facial expressions can comprise short animation clips of the face, where a single static frame is used as a representative facial expression. Examples of such short animation clips can include a yawn, eye-roll, or a facial-twitch.

In a particular case of the user interface, facial expressions can be grouped and organized based on the emotion they convey. For example, a group of happy expressions showing varying facial behavior and intensity of emotion may be displayed together, making it easy for a user to visually browse, explore, compare and select expressions that convey the desired nuances of an emotion. The group of expressions may be further parameterized and displayed based on emotional models of valence (positive or negative emotions) and arousal (intensity of emotion). In another case of the user interface, facial expressions may be grouped and organized to show facial idiosyncrasies of individual characters. Examples of such expressions can include facial asymmetries, persistent eye squints, or a slack jaw. In another case of the user interface, each facial expression can be rendered using a set of action units in real-time on, for example, different 3D character faces. In another case of the user interface, a subset of the n action units comprising a selected expression can be specified, allowing a user to focus their selection to specific parts of the face. Examples of this can include selecting only the parameters controlling the regions around the eyes of the upper face, selecting only the parameters of the jaw, selecting only the parameters controlling the shape of the lips in the lower face, or selecting only the facial parameters of the left (or right) side to specify asymmetry.

In some cases, the user interface provides an interactive timeline to control the temporal behavior of facial expressions. The timeline can include audio samples and aligned textual phonemes or sub-phonemes (e.g., from a transcript), such that users can add selected facial expressions to a portion of the timeline. Expressions created using the timeline can be word-aligned or phoneme-aligned.

As illustrated in figures described herein, the timeline can be represented as a horizontal bar that is annotated with a graphical representation of the audio signal, accompanied with a temporally aligned and displayed text transcript. The timeline can be further interspersed with extendable directorial tags that indicate desired facial behavior. The timeline can be interactively edited by the user by inserting, deleting and modifying such directorial tags. Examples of such directorial tags can include emotion tags with optional valence and/or arousal values, and label tags for specific facial expressions selected from a browser of expressions, as described above. In some cases, multiple tags can be overlaid either concurrently, or with some temporal overlap, on the timeline, to support mixing of complex facial expressions.

In an example, a first channel referred to as ‘heart’ can be used for tags expressing the character's underlying emotions, while a second channel referred to as ‘mask’ can be used for tags that convey the character's voluntarily expressed emotions. In an example, a character trying to hide their excitement can express a happy expression on the ‘heart’ channel, while concurrently presenting a restrained neutral expression on the ‘mask channel’. In further cases, additional channels can be used, with appropriate tags, such as ‘anatomic’ or ‘cognitive’ to capture expressions pertaining to anatomic maintenance like ‘licking lips’, or a ‘faraway gaze’ to convey deep thought, respectively. These combined channels modify the character's facial expressions. In some cases, attack, decay, duration and intensity of various tags can be interactively edited by the user; such as to modulate the facial parameter values of a facial expression that is representative of a tag. In some cases, the timeline can have horizontal tracks for each expression channel.

In some cases, the interface can provide the user with control over the composition of overlapping facial expressions on the timeline. In one such case, the user can choose from a number of operators that control the composition of the facial parameters defined by each facial expression being composed. Examples of such operators are max, min, sum, average, sum-max, max-blend, and any other suitable operators in a facial animation context. Given an i^{th} facial parameter wᵢ that is being composed across k facial expressions, max, min, sum and average would return the maximum, minimum, sum and average, respectively, of the i^{th} parameter value over the k expressions

$${{w}_{i}}^{1} , {{w}_{i}}^{2} , … , {{w}_{i}}^{k} .$$

sum-max, provides behavior where at low activation values get added, but return a value closer to the max for high activation values. One embodiment of sum-max=sum*(1−normalized_max)+max*normalized_max. normalized_max here is the max value divided by the 100% activation value, normalizing the value to the range [0,1]. As a result, when the max value is low activation values add up so they are not too subtle, and become less additive and more like the max as max gets higher, keeping the activation values from getting too big due to the summation. max-blend provides a weighted average of parameter values favoring larger activation values, and can be defined as maxblend

$$( {{w}_{i}}^{1} , {{w}_{i}}^{2} , … , {{w}_{i}}^{k} ) = {{{Σ}^{k}}_{i = 1} ( {w}_{i}^{i} )}^{( a + 1 )} / {{{Σ}^{k}}_{i = 1} ( {w}_{i}^{i} )}^{( a )} ,$$

where the result varies from the average when a=0, towards the maximum as a increases (a default value for the operator can be a=2). The facial parameter values for expressions can also be composed in a given order, where subsequent expression parameter values can further override precedent parameter values

Advantageously, the interface allows users to freely add facial expressions to the timeline in order to generate directed facial expressions, while preserving credibility of the overall facial expression and motion of the animated character. In this way, the resulting animation of the face of the 3D character remains credible in terms of expression and input speech audio. In a particular case, credibility of facial expressions can be preserved by clamping output facial parameter values to within a specified range of motion. In some cases, expression credibility can be enforced by projecting the facial parameter values to a sub-space of parameter values that are trained on a set of credible facial expressions.

In other cases, to preserve fidelity of the facial animation to the input speech audio, lip constraints can be enforced. As an example, a lip-close constraint specified for bilabial phonemes (‘m’,‘b’,‘p’) can ensure that the lips come together during the enunciation of these phonemes. In an example, given any facial expression, lip closure can be enforced by computing the parameter values of blend-shape targets that lower the upper lip, and raise the lower lip respectively; wherein the parameter values for the lower_upperlip and raise_lowerlip are set such that two corresponding landmark mesh vertices on the upper and lower lip respectively, move to the same vertical co-ordinate. In another example, dominant facial parameters required for the enunciation of some phonemes, such as a pucker when emphasizing an ‘o’ or ‘oo’, restrict the setting of any conflicting facial parameters that spread the lips, such as a smile. For facial parameter composition, constraints for expression and speech credibility can be determined subsequent to facial expression tags on the timeline.

In a particular case, each facial expression (or “bearing”) can be defined as a set of action unit activation values corresponding to the expression pose at, for example, intensity=100. The same expression pose can be linearly scaled by intensity values ranging from, for example, 0 to 200; where intensity 100 means the maximum value of the expression is identical to the expression pose, 200 means that the activation value of each action unit in the expression is the value in the expression pose times two, etc. In this way, the maximum intensity of the expression can be defined. The channels can use automatic generation of expression curves, defined by keyframes representing the amount that a particular FACS action unit is activated, based on the audio features and the expression pose.

In some cases, the mask model, the heart model, or both can be based on triggers from an audio or textual sample comprising a dialogue. For example, when the properties of any phonemes or sub-phonemes in the sample deviate from a statistical profile beyond a predetermined threshold; such as determining the standard deviation between the phonemes or sub-phonemes and the statistical profile and triggering the animated behavior when the standard deviation is above the predetermined threshold. In some cases, the triggers for the activation values can be from determining animation curves for the triggered behavior that alter geometry of an animated character from a current state to the triggered behavior, then hold the paralingual behavior for a period of time, and then alter the geometry of the animated character back to a state prior to the triggered behavior.

In further cases, animation curves can be determined for the triggered animated behavior that alter geometry of the animated character from a current state to the triggered behavior, hold the behavior for a period of time, and alter the geometry of the animated character back to a state prior to the behavior, in order to output animation curves.

In this way, an inputted corpus of dialogue can be used to create a statistical profile of the utterances. Each sample of dialogue can be treated as a vocal signal that is processed to extract various tonal aspects, for example, volume and pitch. A time unit that can be used is the duration of each phoneme. For example, the mean pitch of the phoneme is determined, as well as the minima and maxima of each phoneme duration.

In some cases, the statistical profile can be generated for speaker of a character based on a statistical analysis of the speaker of the corpus of dialogue. In some cases, the same voice actor performing two or more different roles can be distinguished because phoneme durations and sub-phoneme signals would be different between voices, as would the overall pitch, the volume of certain phonemes, and other properties.

A deviation from the statistical properties for a particular phoneme in the stream of phonemes can be used to trigger the animated behavior. In some cases, this triggering can include enhancing or diminishing a particular behavior. In a particular case, the deviation can be based on a measurement of standard deviation (stddev); for example, the behavior can be triggered when the property is greater than one stand deviation, however other triggering values can be used as appropriate. In further cases, other deviation comparisons can be used; for example, when an absolute value of the difference is greater than a predetermined threshold.

In an example, one standard deviation can be used as a threshold which triggers an animation, while two standard deviations can trigger an even greater amplitude animation (a higher apex), such as at or very near a maximum of amplitude for the animation. These standard deviation thresholds can be any suitable value, or received from the user; such as reduced categorically to make for a more sensitive system which would trigger at lower pitch/volume which would give a more animated performance. Or the threshold can be increased creating higher thresholds, a less sensitive system, and a less animated performance. Generally, each phoneme can be evaluated against the statistical profile in order, and if it is above or below the threshold, an animation is produced at the time of the phoneme and with an amplitude defined by the degree of the deviation.

In some cases, the visual appearance of the animated character can be defined digitally using a polygon mesh; i.e., a discrete set of points connected by geometric elements such as polygons. Other examples of geometric representation include parametric surfaces, subdivision surfaces, or implicit surfaces. This geometry can be animated by prescribing the motion of individual geometry points over time, or by functionally relating the motions of these points to a set of high-level parameters, sometimes referred to as a ‘character rig’. A character rig for faces can include a set of target shapes defining various facial expressions, whose point positions are linearly combined using a set of blend shape weights. In other words, a character rig can be thought of as a function f that deforms a set of points P=[p₁ p₂ . . . pₘ](which can be arranged in a matrix of points) on the character geometry. The points on the character geometry can represent facial skin, hair, and other parts of the face (e.g., tongue and teeth), and/or invisible anatomy (e.g., skull or jawbone). The points P are deformed for a set of n rig parameters W=[w₁, . . . , wₙ](arranged as a vector). In the case of blend shapes, that often capture facial expression targets from the FACS (facial action coding system), corresponding to each weight wᵢ is a target shape Tᵢ=[t₁, t₂ . . . tₘ] (which can be arranged in a matrix) with target geometric points tᵢ corresponding to the undeformed character point pⱼ. For the points in matrix form, then f (P,W)=P+Σᵢ₌₁ⁿ wᵢ*(Tᵢ−P).

In accordance with the present embodiments, an animated behavior (as an expression or pose) can be defined using values for a subset E={e₁, e₂, . . . , eₖ} of the character rig parameters. The animated expression can be expressed by interpolating each eᵢ from its current state to that of the expression over the attack phase. The expression is held over the sustain period and then interpolated back over the decay interval to the current state of that character at the end of the paralingual behavior. In some cases, the animated behavior can be overlaid relative to the current state of the character. For example, a motion of a head shaking left to right and back can be overlaid as a relative change to the parameters of a character head that may already be oriented left (or right).

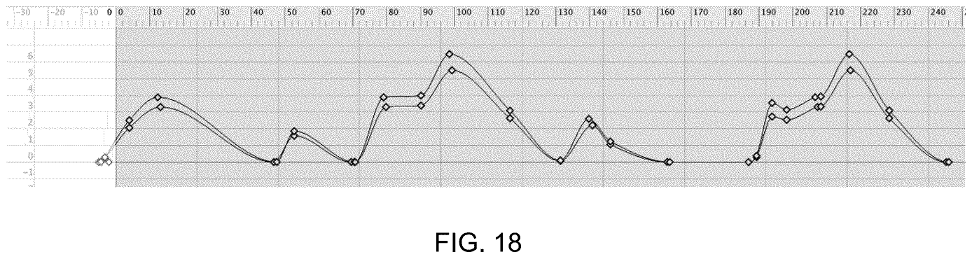

Using a database of animated behaviors, the most appropriate animation can be selected, if any. In an example, consider an animation curve, illustrated in FIG. 18, that is anchored at the background level (often neutral, or 0) at a minimum of 120 ms before the start of the triggering phoneme and to a maximum of 500 ms. The apex is the full expression of the animated behavior on the face (in some cases, mixing with a background expression). The animated behavior sustains for a period of time in arching down to 85% to 60% of it's apex value then transitions back to the background state for each part of the animated behavior, or to a lower than sustain/apex but higher than original background state if the animation definition, cognitive model, or emotional state indicates it should be. If another triggering event takes place, the new animated behavior will be animated over the previous animated behavior, with the old animated behavior as a background state of the new animated behavior.

In some cases, a mask model can be used for the mask channel and a heart model can be used for the heart channel. The heart model can use arousal level directly to determine the activation of the expression. The arousal level can be determined as the amount that the intensity (i.e., loudness) and pitch of the phoneme when compared to other phonemes of the same class in the speech corpus. A higher activation of the model corresponds to a linear increase in the contribution of the expression to each action unit. The expression pose, modified by the selected intensity, becomes the maximum value of the expression. In some cases, the minimum value can also be set by the user. In this way, the total activation contributed by the expression at that action unit can be represented by:

Activation value at a given action unit=MAXIMUM(expression channel activation*expression pose value at that action unit*intensity,minimum activation value set by the user*expression pose value at that action unit*intensity)

This activation value can be combined with the activation from other sources; for example, speech animation and other expression channels that are active.

In a particular case of the present embodiments, both the heart and mask model can generate activation values based on a statistical profile of utterances from a received dialogue. A profile can be generated per-phoneme, or per-sub-phoneme, from a corpus for a speaker, from a general corpus if no per-speaker corpus is available, or from a subset of a corpus (such as a single clip or small group of clips) if a whole corpus is not available. Per-phoneme, or per-sub-phoneme, frequency distribution for audio features, such as pitch and intensity, can be stored as reference values.

“Static expressions” can be defined in terms of one pose (called an “expression pose”); which can be defined by how much each action unit is activated when the expression is triggered. For example, a polite expression may activate the action units for making the face smile a comparatively large amount (activating AU 12 Smile L and AU 12 Smile R by 7 units out of a possible 10 units), but increase another set of action units, for example those for raising the brows (AU 01 InnerBrowRaise_L and AU 01 InnerBrowRaise_R by 5 units out of a possible 10). But the expression will generally also have time varying behavior that linearly scales this expression pose over time, which can be triggered by a function derived from how the phonemes vary from reference values in a corpus; e.g., how many standard deviations they are from the mean.

The basis for when time varying behaviour is triggered can be referred to as an “arousal function”. There are various suitable ways to define an arousal function, such as by using a z score of two per-phoneme audio features, pitch and intensity. Arousal is maximized (e.g., =4) when both have z scores greater than 1 (at least one standard deviation above the mean) and arousal is minimized (e.g., =−4) when both have z scores less than −1 (at least one standard deviation below the mean); with in-between cases being handled similarly. A customizable factor can be used (e.g., of up to 2) in order to boost the arousal for long phonemes (e.g., for phonemes with duration above, for example, 750 ms) as a multiplicative factor to increase the arousal; but generally arousal can be clipped, for example, at 4. Other arousal functions are possible, including functions that are based on different audio features; for example, intensity alone, pitch alone, or other audio features like shimmer or overtones, or non-audio features, such as cognitive models of the character being animated, or models of the semantic content of what the character can see or hear.

In determining whether a mask is active, the system 100 can compare the arousal value to a user-defined threshold. Then, probabilistically, according to a user-defined probability, it can be determined whether the mask will be activated if it surpasses the threshold. Then, multiple keyframes can be written for different phases of the mask activation, including but not limited to, the anchor, apex rise, apex, apex drop, and sustain of the curve. The mask can be retriggered partway through, in which case, a new overlapping mask curve is inserted, overwriting previous keyframes.

The heart model can use a different set of rules to determine when the behavior is triggered, which results in less complex curves that vary less over time (lower frequency time-varying behavior). In order to achieve sparse keying and smooth gradients for the heart model, a buoying approach can be used. Since the underlying state of the heart model at a given time can be determined as a linear transformation of the arousal, it has the potential to have large gradients as the arousal signal can be generally noisy and have large changes per phoneme. In order to achieve sparse keys and small instantaneous gradients that characterize the heart model, a buoying mechanism can be employed. On a per-action unit basis, the previous arousal value and time of keying for which the last key for the heart channel was set are stored. Then, the absolute difference in arousal between the current phoneme and the buoy value can be compared against a threshold, along with the absolute difference in times between the current phoneme and buoy time. If both are greater than the empirically determined threshold, a heart key can be added and the buoys can be updated.

Advantageously, different expression channels can be combined into a single expression curve for each facial action unit where multiple expression channels (e.g., heart and mask channels) have been applied to either the same word or phoneme in the timeline or to longer portions of audio. In such cases, an arousal value can be determined as the amount that the intensity (i.e., loudness) and pitch of the phoneme compared to other phonemes of the same class in the speech corpus, or a subset of that corpus spoken by a particular speaker, or by a single audio clip. The arousal value is increased for long phonemes and can be increased for phonemes belonging to words from a subset or dictionary that correspond to moments in the text when it is likely that an expression should be triggered (e.g., “heh” corresponding to laughter). In some cases, a single dominant channel can be selected for each action unit at each phoneme based on the value of each channel for that phoneme.

In a particular case, channel mixing modes can include maximum (‘MAX’), minimum (‘MIN’), average (‘AVG’), and additive (‘SUM’).

Since the rate at which keyframes are set can vary across channels (e.g., in some implementations, mask channel sets keyframes much more frequently than heart channel), different action units can have different time-varying behaviors based on which expression channel is dominant. In a particular case, selection of the dominant channel can include:
(1) Selecting the dominant channel by comparing the underlying activation values for both expression channels (in most cases, without considering how they will interact). The comparison operator can select between MAX and MIN.
(2) Ensuring that the same channel is always dominant across both copies of action units on either side of the face to prevent asymmetric time-varying behavior, which can be distracting. For example, if the heart channel is dominant for action smile left (smile_L), the heart channel will also be dominant for smile right (smile_R).
(3) Selecting the activation value for each keyframe that will be set within the phoneme. For the non-dominant channel, a residual activation value can be generated that will apply to all keyframes within that phoneme. Then, for any keyframes within that phoneme (which will be at most one for the heart expression channel and at least one for the mask expression channel), the residual is compared against the value of the dominant channel and mixed using a selected channel mixing mode (MAX, MIN, SUM or AVG).

In some cases, some channels (e.g., channels including blinks, head shaking, etc.) may not be combined as described above, and either restricted to action units not affected by other channels, or only combined additively.

In some cases, by using specifically generated expressions, the system 100 can ensure that one channel does not contribute to a specific part of the face. For example, a heart expression “angry_lower_face” can be generated where all of the action units affecting the brows (e.g. brow_raise, brow_furrow) are set to 0. This would mean that the behavior of the brows would be set entirely by the heart expression channel.

The system 100 can advantageously generate realistic and valid facial expressions by constraining values of the FACS action unit curves after the speech and expression curves have been generated. This constraining approach removes cases where either speech curves, expression curves, or a combination of the speech and expression curves, may create unrealistic facial behavior.

Firstly, the system 100 can act on activation values of lip-stretching facial action units (e.g., AU10, AU12, AU14, AU20) driven by activation values of a pucker action unit (e.g., AU18). Since these facial action units are practically impossible to activate simultaneously because they act in opposite directions, this prevents unrealistic speech. For example, preventing the lips from being stretched by a smile expression but the lips must pucker to create ‘a’. The attenuation can have several possible shapes, for example:
lip-stretching multiplied by the square of the inverted pucker (0-1).
a lip-stretching attenuated by the inverted pucker (0-1).
a lip-stretching not attenuated by pucker (i.e. TURNED OFF).

After attenuation, if attenuation took place, the lip-stretching action units are increased by a constant value. For example, for action unit 10 (lipSneer), the updated value of au10 for the above three examples of shapes would be:

$au10=$peo+($au10in*pow((1−$au18),2)) puckerEffect 0:

$au10=$peo+($au10in*(1−$au18)) puckerEffect 1:

$au10=$au10in puckerEffect 2 (TURNED OFF):

where $peo=PuckerEffect_offset, w_10$au10in=lipSneer in value, and $au10=lipSneer out value.

Further, a lipStick pose can be inserted that causes lip corners to stick together. The lipStick pose is attenuated as the jaw is opened. This is because, physically, the lips will stick together due to mouth moisture and stickiness until the jaw opens. This allows for speech, expression, or speech and expression, to be animated and combined realistically for poses where the jaw is mostly closed

Further, the jaw and/or lip can be forcibly closed for certain phonemes. For example:
The system 100 can enforce that the jaw is closed on the output character rig for the following phonemes or phoneme groups: “Th”, “R”, “SZ”, “ShChZh”, “JY”, “LNTD”, “LNTDa”, “GK”, “GKa”, “Tha”, “Ma”, “BPa”, “FVa”, “Wa”, “Ya”, “Ja”, and “Ra”
The system can enforce that the lips are closed on the output character rig for the following phonemes or phoneme groups: “M”, “BP”, “FV”, “W”, “Ma”, “BPa”, “FVa”, and “Wa”

Further, an “Emotion_onSpeech” parameter can be used to select a maximum value on each action unit when merging the activation values coming from the speech animation and the activation values coming from the composite expression curves. This ensures that, for example, if a smile expression is added on top of a part of the speech animation, it results in a very open mouth. This parameter can also optionally be set to additive to disable this behavior.

Since speech is typically symmetrical and expressions are often asymmetrical, the speech can be written to symmetrical controls and expressions can be written to asymmetrical controls. These curves can be implemented in either the rigging layer, or in a library that generates the animation curves. In some cases, these curves can be clipped by a user's rig logic if they would exceed the range of any of the individual controls. In an example, these curves can be additively balanced using the following:

a_out=a_in+min(l_in,r_in)

l_out=l_in −min(l_in,r_in)

r_out=r_in −min(l_in,r_in)
where:
   a_in is the symmetric AU user/animation input
   l_in is the left AU input
   r_in is the right AU input
and:
   a_out is the symmetric AU output after the transform
   l_out is the left AU output after the transform
   r_out is the right AU output after the transform

In some cases, an “expression gallery” can be presented to the user on the user interface by animating the face through a range of intensity values; which correspond to linear interpolation between the neutral face and the expression pose. In some cases, a representative frame can be chosen as a thumbnail for the expression gallery; for example, the expression pose at an intensity value of 100. To select a bearing of the expression, the user can select one of the thumbnails in the gallery presented by the user interface. The user can likewise also select the intensity of the expression. In some cases, separate galleries can be generated for separate characters so that the appearance of the character in the thumbnails can match the character rig being animated.

In some cases, the system 100 can be incorporated into a digital content creation tool, whereby the character rig can be directly controlled by the intensity slider to observe what the expression looks like on the character at a given intensity. The full expression and speech performance, corresponding to a selection of expression channels with set speech parameters, can be previewed with corresponding audio.

In some cases, tags corresponding to a combination of expression bearing and intensity (e.g. “heart” expression channel, intensity level 120, angry bearing) can be applied to portions of the timeline (intervals of words or phonemes). Each expression channel, where there is more than one, can be tagged separately. In some cases, tags from different channels can overlap. For example, a user can add a tag by clicking on the timeline, or by highlighting words in the timeline to define the words that will be covered by the tag, and then selecting to add a tag in the timeline. In some cases, the user can drag and drop a tag to change its position on the timeline, or extend its bounds by clicking and dragging the edge of a tag. After a tag has been modified, in some cases, its bounds can snap to be word-aligned or phoneme-aligned. Similarly a user can delete a tag by selecting a tag in the user interface and choosing to delete it.

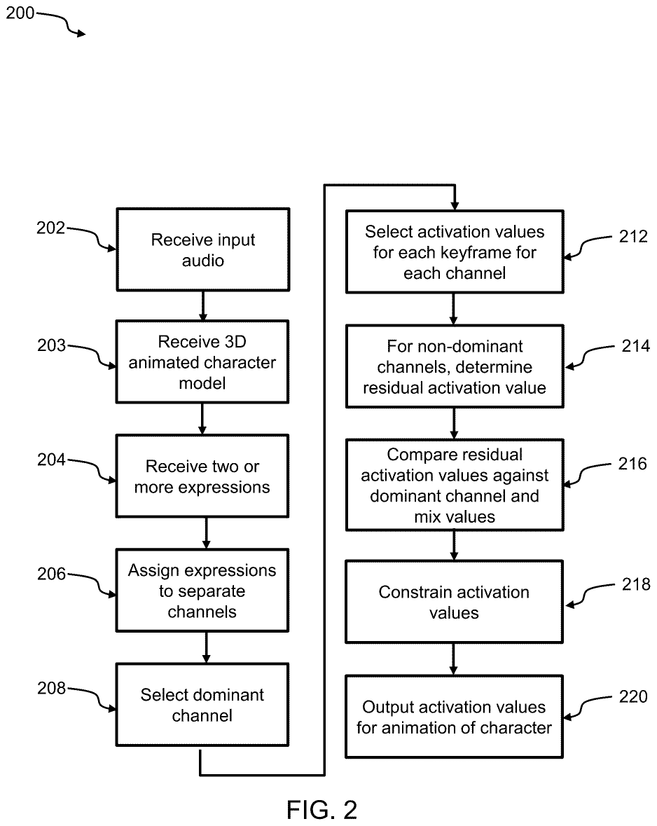

Turning to FIG. 2, a flowchart for a method for combining and controlling of expressive animated facial behavior 200 is shown. The method 200 advantageously allows a user to combine and/or layer two or more expressions on a single 3D character to animate the character in a fashion that is realistic to normal human facial behaviour. In this way, user selected facial expressions are used to produce facial animation that is faithful to received audio/dialogue.

In some cases, at block 202, captured audio is received by the input module 102 from the input device 122 or the storage device 124. In certain cases, the captured audio can also include associated textual transcript/lyrics. In other cases, the associated textual transcript/lyrics can be generated by the input module 102 using any suitable audio to text methodology. In some cases, the transcript can further be embedded with computer-readable tags that provide directives to convey emotion or other expressive facial behavior. In some cases, the tagging module 104 can temporally align phonemes or sub-phonemes in the transcript with corresponding samples in the speech audio, for example, using forced alignment.

In some cases, at block 203, the character module 106 receives a 3D animated character model for animating the expressions. In other cases, such as in the absence of 3D animated character input, the character module 106 automatically generates a 3D animated character from the received input speech audio and transcript using any suitable technique.

At block 204, the input module 102, via the input device 122 or the storage device 124, receives two or more expressions to be expressed on the animated character and a timeframe (for example, a duration of keyframes) for which the expressions are to be animated. Generally, the expressions are comprised of activation values (or values) for one or more action units on the animated character. In most cases, at least two of the expressions overlap for a period of time, for example, overlapping during a given phoneme or sub-phoneme.

In particular cases, the two or more expressions, and their parameters and duration, can be received from the user interface. The parameters received can include a scaled intensity value (for example, between 1 and 200). Generally, expression curves for the received expressions can be used and defined by keyframes representing the amount that a particular action unit is activated. A higher activation corresponds to a linear increase in the contribution of the expression to each action unit. In some cases, an expression pose, modified by the received intensity parameter, can be a maximum value of the expression. In some cases, a minimum value can also be received from the user.

In some cases, the user interface provided by the input module 102 can receive selections from the user via the use of a presented gallery of expressions. Such gallery can be displayed by animating the character through a range of intensity values, which can corresponds to a linear interpolation between a neutral pose and the expression pose.

At block 206, the expression module 112 assigns each of the received expressions into a separate channel. For example, a ‘heart’ channel for a first received expression and a ‘mask’ channel for a second received expression.

Generally, the channels will have an order such that one of the channels can be dominant and more overtly represented on the animated character (e.g., mask channel) and other channels can be more subtly represented on the animated character (e.g., heart channel). In some cases, at block 208, the expression module 112 can automatically select the dominant channel by comparing the underlying activation values for the two or more expression channels to determine which activation values are greater. In other cases, the channel designation for each of the received expressions can be received as a selection from the user via the input module 102.

The underlying activation value generally means the per-phoneme, per-action unit value of the activation function for each channel that would be keyed, regardless of whether it is actually keyed. For example, although a heart function can be qualitatively very smooth, the underlying activation value can be much more variable. The smoothness of the heart function is because of the fact that the heart channel keyframe insertion function inserts fewer keyframes. The “underlying activation values” can be determined based on an arousal value as defined herein. The underlying values can be defined as:

Underlying activation_value=activation_coeff*au_value.

For determining the activation coefficients for both channels:
The heart coefficient can be the arousal value described herein, linearly scaled into the range:
   [heart_minimum_strength, heart_maximum_strength].

For the activation coefficient of the mask channel, it can be determined by:
determine mask_coeff based on activation (i.e., has it recently passed a user defined threshold of arousal value, above which there is the chance to trigger the mask channel), activation probability (what percentage of the time, when the threshold is passed, does the mask channel activate), and current arousal value.
If the mask is deactivated, mask_coeff=minimum_intensity
If the mask is activated, mask_coeff is the arousal linearly scaled into the range:
   [mask_minimum_intensity,mask_maximum_intensity]
If the Mask has passed its peak and is beginning to fall, the mask_coeff is, for example, 0.61 times what it would be if the mask were activated.

At block 212, the activation module 114 retrieves the activation values of action units for selected keyframes for a selected duration (such as for a given phoneme or sub-phoneme) from each channel, in order to combine the received expressions. As above, the selection of which channel each expression is associated with can be received from user input (for example, in the form of tags). The keyframes are selected based on the number of keyframes in the dominant channel. In this way, the temporal frequency of the keyframes is set by the expression in the dominant channel. In this way, the dominant channel controls the time sampling of the animation curves where there is expression overlap of the channels.

At block 214, in some cases, for non-dominant channels, the activation module 114 determines a residual activation value that applies to all keyframes for a given duration, for example, a single value for the length of a phoneme or sub-phoneme. The residual value only affects the values of the activation values at the keyframes, not the number of keyframes or their positions. In some cases, the residual activation values do not affect the time-varying shape of the combined expression curve, just the scale.

At block 216, for the selected keyframes within the duration, the activation module 114 combines the residual activation values for the non-dominant channels against the value of the dominant channel at that keyframe and mixes the activation values using a selected channel mixing approach (e.g., maximum, minimum, average, sum, sum-max, and max-blend).

In this way, mixing can be performed on a per-action-unit level when mixing two expression layers. Expressions that are associated with the mask channel have keyframes that are sampled at a frequency that is representative of such expression, and expressions that are associated with the mask channel will use the keyframe frequency of the mask channel regardless of the expression. As an example, suppose the expression in the heart channel is activating an eye lid to twitch rapidly, but the mask channel is activating at a low frequency with few keyframes. With the mask as the dominant channel, much of the eye lid twitching will disappear due to getting washed out because only a few keyframes are being used. Note that the activation value of the actual eye lid action unit at any such keyframe will be set by the selected mixing modes described herein.

In some cases, the activation module 114 coordinates similar action units to be activated on both sides of the face to avoid odd inconsistencies across the face.

In an example, a user can assign a mask channel with tagging a first expression (e.g., surprised) and assign a heart channel by tagging a second expression (e.g., angry). The expression pose is set by the expression (angry for mask, surprised for heart) and the intensity is set by the intensity value of the tag (for example, intensity is 140 for the mask, and intensity is 20 for the heart. In this example, the tags can be associated with a phrase (“The Quality of Mercy, from the Merchant of Venice. Act Four, Scene One”) expressed as below:
<mask=angry-140>
<heart=surprised-20>
   The Quality of Mercy, from the Merchant of Venice. Act Four, Scene One.
</mask=angry-140>
</heart=surprised-20>

The mixing modes can be used for the selection of the dominant channel based on the underlying activation values. In the case of average, additive, or maximum mixing modes, the channel with the higher underlying activation value will be dominant. In the case of minimum mixing mode, the channel with the lower underlying activation value will be dominant.

The mixing modes can also govern how the residual values of the non-dominant channel will influence the dominant channel. The combination of the heart channel values and mask channel values can be provided to the dominant channel's keyframe insertion function according to the mixing mode (see pseudocode below), and thus, even mixing modes that use the same dominance selection approach can result in different output curve shapes.

Maximum mixing will take the largest value of the two or more channels as the activation value of an action unit at a given keyframe. It will generally capture the moments of high mask activation effectively without compounding them with the ambient expression and can result in a smooth transition between channel dominances. Maximum mixing is useful to stop output values from becoming too large if the values on both channels are near the top of an allowable range, and will prevent the values from growing in an unbounded fashion as the number of channels increases.

Additive mixing will take the summation of the values of the two or more channels as the activation value of an action unit at a given keyframe. It is generally useful if a user desires to capture all time-varying expression behavior from emotional channels, but is more brittle, as it can easily result in large output values.

Minimum mixing will take the smallest value of the two or more channels as the activation value of an action unit at a given keyframe. It can capture small nuances that would otherwise be lost and delivers a more muted performance. For example, where channels are set to high intensity values, this may result in large deformations that may overly distort the appearance of the character rig. In such case, selecting the minimum value mixing mode provides a more conservative choice than maximum mixing, since if even one of the channels is at a lower value that results in less distortion, the output will be set to that lower value.

Average mixing will take the average value of the two or more channels as the activation value of an action unit at a given keyframe. It is useful in similar circumstances to maximum mixing, since it will also produce a value that is upper-bounded by the maximum, but it captures the intersection of independent emotions by averaging, resulting in a less dramatic performance.

Maximum mixing generally captures a qualitatively described phenomena of emotional leakage; where behavior representing one emotional state (for example, a heart channel emotion) can be generally covered by behavior representing another emotional state, except when it reaches a certain degree of intensity, at which point it will become visible through “micro leakage” or small changes in behavior. This has been noted to occur specifically for human faces. Because of the maximum dominance selection rule, this leakage behavior also occurs in a less pronounced way for the additive and average mixing mode.

Having multiple mixing modes available is beneficial to a user because it allows the user to quickly examine multiple alternative ways of combining the two or more emotional channels.

Other potential mixing modes are possible. For example, add-max, which will take the added value of the two or more channels as the activation value of an action unit at a given keyframe where the channels have activation values that are low; and where such channels have activation values that are higher, the mixing will perform maximum mixing as described above. For example, the add-max mixing can be in accordance with the following:

$$V = sum * ( 1 - max ) + max * max ,$$

Thus, when the max values are low, this mixing mode adds up the activation values so they are not animated too subtly, but the mixing becomes less additive and more like the max mixing mode as the maximum value of the activation functions get higher. This mixing mode keeps the activation values from getting too big due to the summation behavior.

At block 218, the constraint module 116 constrains the activation values determined by the activation module 114 in order to produce valid facial expressions; for example, to a selected threshold value for each respective action unit or collections of action units. In some cases, the constraints can be a maximum threshold, such that a particular action unit, or combination of actions units, do not go over a set threshold or realism. In some cases, the constraints can be based on speech, such that lip and/or mouth action units are constrained to produce mouth shapes for a given sound; such as ensuring lips closure for the phoneme /b/ or ensuring lip separation for the phoneme /ov/. In some cases, the constraints can be based on other limitations, for example, a character holding their eye closed would mean that the action units for such eye would be constrained to be touching.

At block 220, the output module 110 outputs the activation values to the output device 126, or the storage device 124, for animating the character.

Advantageously, the combination of dominant and non-dominant expressions allows for more realistic animation of a character's expressions. In an example, allowing for a more overt happiness expression to be expressed while also displaying expressions of slight nervousness.

For example, when using a maximum mixing mode, if the animated character is raising their eyebrows (on an eyebrow action unit) due to an expression in the mask channel (i.e., due to a social mask the character is desirous to display), but the expression in the heart channel is also raising the eyebrows, the system 100 would not show the heart value of the eyebrow action unit unless the value of the heart activation exceeds the activation of the mask channel. Thus, if the heart channel is activating the eyebrow action unit at 50%, it will be hidden if the mask channel is activating the eyebrow action unit at 75%. Later in the performance, the heart channel is activating the eyebrow action unit at 80%, and the mask channel is still activating the eyebrow action unit at 75%, then the expressions in the heart channel would be ‘leaking’ through the social mask by 5%. As the activation values in the heart channel continue to rise to 100%, then the heart will become the dominant emotion that's driving this particular action unit. This leakage is realistic to how people generally try to suppress internal emotions, but such suppressed emotions often leak through their social mask.

Below is a pseudocode example of curve mixing, in accordance with an embodiment. The example is provided in terms of an action unit with symmetrical left/right components (e.g., left eye close, right eye close). This occurs frequently on human faces because of bilateral symmetry. Where there are multiple components of an action unit, for example, a left and right component of a lip sneer action unit, on the left and right sides of the face, the system 100 ensures that the same channel is expressed similarly across all components of the symmetrical action units. It does so by performing the dominance calculation simultaneously by way of adding together the heart_value for all components of symmetrical action units, and performing the same for the mask_value before comparison. This prevents asymmetrical time varying behavior that can be distracting. Such restrictions can be extended to other action units that are not purely left/right symmetrical. For example, for a spider with eight eyes, where the user would like the eyes to be coordinated in their behavior, the system 100 could perform the same determination, but for each of the eight subcomponents of the action unit and not just for the two subcomponents that are present in the left/right case.

### For Each Phoneme:

Populate current_mask and current_heart vectors corresponding to the au activation values defining those expressions based on the current tag.
Create a mask vector animate_heart to indicate whether heart or mask will be animated.
Calculate an underlying activation value (also referred to as arousal value) based on standard deviations of pitch, intensity, and the like.

### For Each Action Unit:

First determine which channel will be selected for animation
Determine the “underlying activation values”
   Determine mask_coeff based on position in activation, activation probability, and current arousal value. If the mask is deactivated, mask_coeff=minimum_intensity. If the mask is activated, mask_coeff is the arousal linearly scaled into the range
   [mask_minimum_intensity, mask_maximum_intensity]. If the mask is beginning to fall, mask_coeff is 0.61 times what it would be if the mask were activated.
   Determine heart_coeff by linearly scaling the arousal into the range
   [heart_minimum_strength, heart_maximum_strength].
Note: In this case, an AU is being considered with left/right versions or subcomponents. For example, Smile L(eft) pulls up the left corner of the mouth and Smile R(ight) pulls up the right corner of the mouth. The action units are numbered as sequences of pairs in an array where au is the index of the left action unit and au+1 is the index of the right action unit.
The underlying activation values are scaled by how much the expressions that are selected for the mask and heart channels activate this action unit (current_mask and current_heart). For example, a happy expression would highly activate the smile AU while a surprised expression may not activate it at all

Mask_val_l=mask_coeff*current_mask[au]

Mask_val_r=mask_coeff*current_mask[au+1]

Heart_val_l=heart_coeff*current_heart[au]

Heart_val_lr=heart_coeff*current_heart[au+1]

Mask_val_lr=mask_val_l+mask_val_r

Heart_val_lr=heart_val_l+heart_val_r
Now the dominant channel is the one for which the corresponding value of mask_val_lr or heart_val_lr is maximized (in the cases of maximum, average, or additive mixing) or the one where the corresponding value is minimized (for minimum mixing). The dominant channel is the one which will later be used for keyframe insertion.
   If (maximum_mixing OR average_mixing OR additive mixing)
      If Mask_val_lr>Heart_val_lr:

animating_mask=True
else:

animating_mask=False
Else If (minimum_mixing):
   If Mask_val_lr<Heart_val_lr:

animating_mask=True
else:

animating_mask=False
Mixing can then be performed to modify the maximum_strength and current au value before calling the animation. Note that both left and right can be mixed individually, whereas the dominance selection happens across the sides. The overall aim here is to set current_{mask|heart}[au], current_{mask|heart}[au+1], current_maximum_strength[au], and current_maximum_strength[au+1] such that the left and right are mixed according to the user specified rule.
   If (maximum mixing)
While one system may be dominant overall for the left/right action unit, another could still be greater on a per side level. The values will be set to the ones corresponding to the maximum of mask_val_l and heart_val_l for the left and similarly for the right
   If Mask_val_l>Heart_val_l

Current_strength_l=mask_intensity

Current_expression[au]=current_mask[au]
Else

Current_strength_l=heart_intensity

Current_expression[au]=current_heart[au]
If Mask_val_r>Heart_val_r

Current_strength_r=mask_intensit

Current_expression[au+1]=current_mask[au+1]
Else

Current_strength_r=heart_intensity

Current_expression[au+1]=current_heart[au+1]
If (minimum_mixing)
If Mask_val_l<Heart_val_l

Current_strength_l=mask_intensity

Current_expression[au]=current_mask[au]
Else

Current_strength_l=heart_intensity

Current_expression[au]=current_heart[au]
If Mask_val_r<Heart_val_r

Current_strength_r=mask_intensity

Current_expression[au+1]=current_mask[au+1]
Else

Current_strength_r=heart_intensity

Current_expression[au+1]=current_heart[au+1]
If (average_mixing)

Current_expression[au]=(current_mask[au]+current_heart[au])*0.5

Current_strength_l=(heart_intensity+mask_intensity)*0.5

Current_expression[au+1]=(current_mask[au+1]+current_heart[au+1])*0.5

Current_strength_r=Current_strength_l
If (additive_mixing)

Current_expression[au]=current_mask[au]+current_heart[au]

Current_strength_l=heart_intensity+mask_intensity)

Current_expression[au+1]=current_mask[au+1]+current_heart[au+1])

Current_strength_r=Current_strength_l
This approach allows the system to capture the shape of the dominant channel while accounting for residual effects across left and right and across channels according to the selected mixing rule.
   If (animating_mask)

animate_mask(au,current_expression,current_strength_l)

animate_mask(au+1,current_expression,current_strength_r)
Else

animate_heart(au,current_expression,current_strength_l)

animate_heart(au+1,current_expression,current_strength_r)

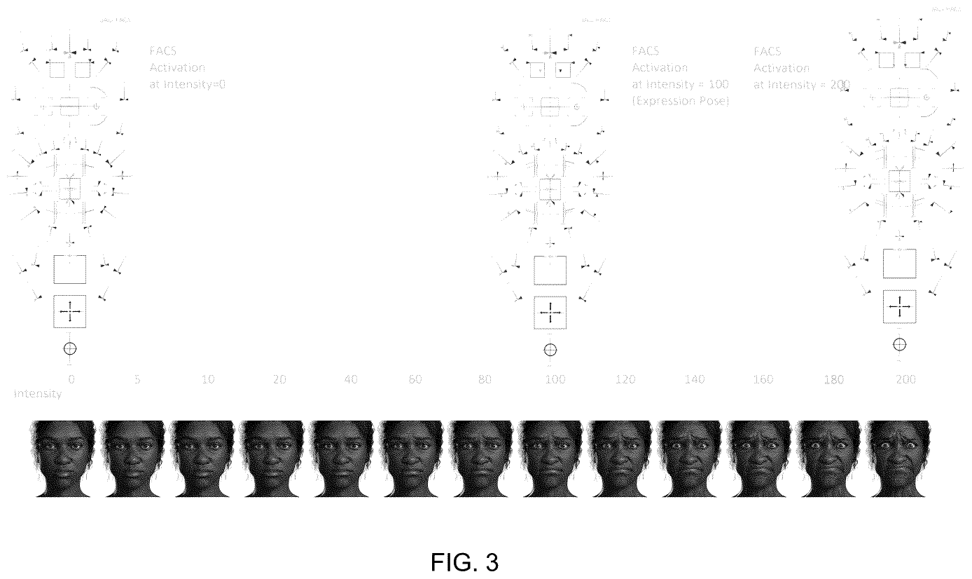

FIG. 3 illustrates an example of expression pose activation values on a FACS control board for different intensity values (0%, 100%, and 200%), and facial deformations on an example character rig corresponding to the expression pose corresponding to that intensity value. On the FACS rig, shown are three different sliders, each corresponding to one action unit. One of the sliders control the left-side face copy of the action unit (AU), another one of the sliders represent the right-side face copy of that AU, and the last slider represents the symmetric AU control that affects both left and right sides.

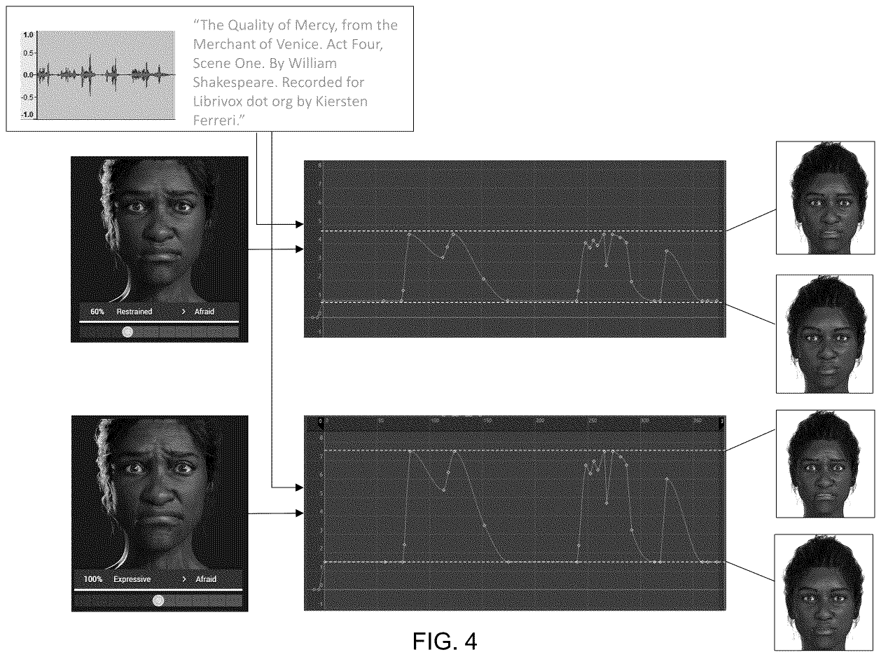

FIG. 4 illustrates a input text and .wav file pair, in order to show how the output deformation on the character rig is affected by two different independent inputs that could be provided for the mask expression channel (no heart channel is applied in this image). The user selects a bearing of “Afraid” for mask. In the top instance, they provide an intensity of 60% for the “Afraid” Mask channel. In the bottom instance, they provide an intensity of 100% for the “Afraid” Mask channel.

In this case, because there is no other channels to mix with, the mask expression will be applied the same way to all AUs. Based on how many standard deviations by which phonemes differ from the reference values, the mask channel will trigger changes in the AUs. In this case, it can be seen that the time-varying behavior is the same, scaled by the intensity of the mask emotion.

The pictured AU is “AU 1 Inner Brow Raise Left”, which is representative of the mask channel in general. It will be unaffected by the speech curves because brows are not involved in creating the phoneme shapes. The images corresponding to the minimum and maximum values of the Inner Brow Raise AU show the maximum and minimum deformation of the entire character face in accordance with the selected emotion. Because there is only one expression channel active, all AUs in the expression will share the same time varying behavior until they are mixed with the speech curves.

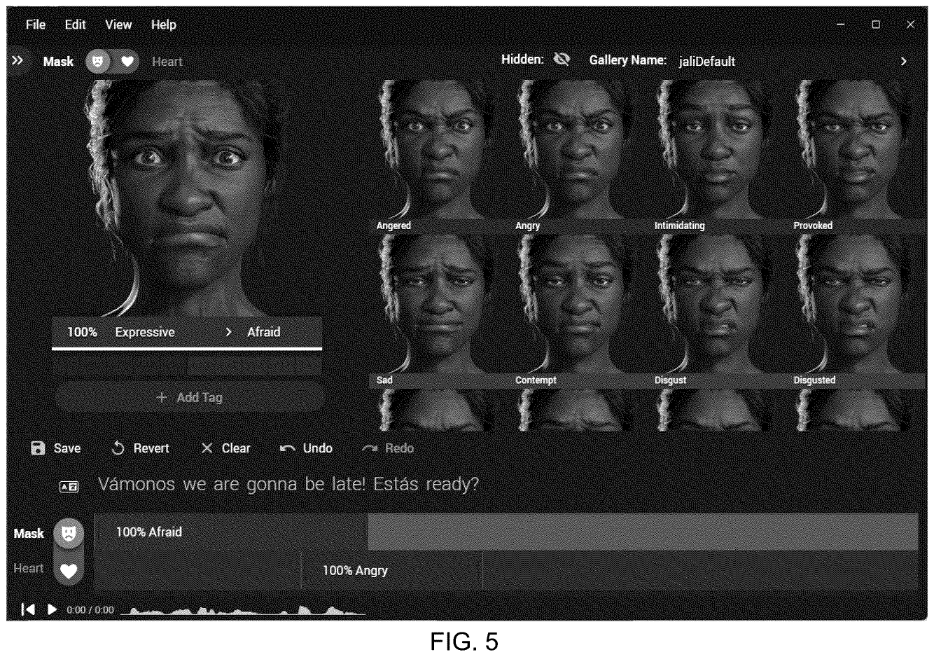

FIG. 5 illustrates an example tagging interface and expression browser, as part of the user interface of the present embodiments. A mask channel tag (Bearing Afraid, Intensity 100%) is applied to part of the phoneme-aligned text transcript, and a heart channel tag (Bearing Angry, Intensity 100%) is applied to another partially overlapping part of the text transcript. The audio wave form is visible at the bottom of the interface. A collection of other possible mask emotion bearings is visible in an expression browser, with similar emotion bearings sorted together.

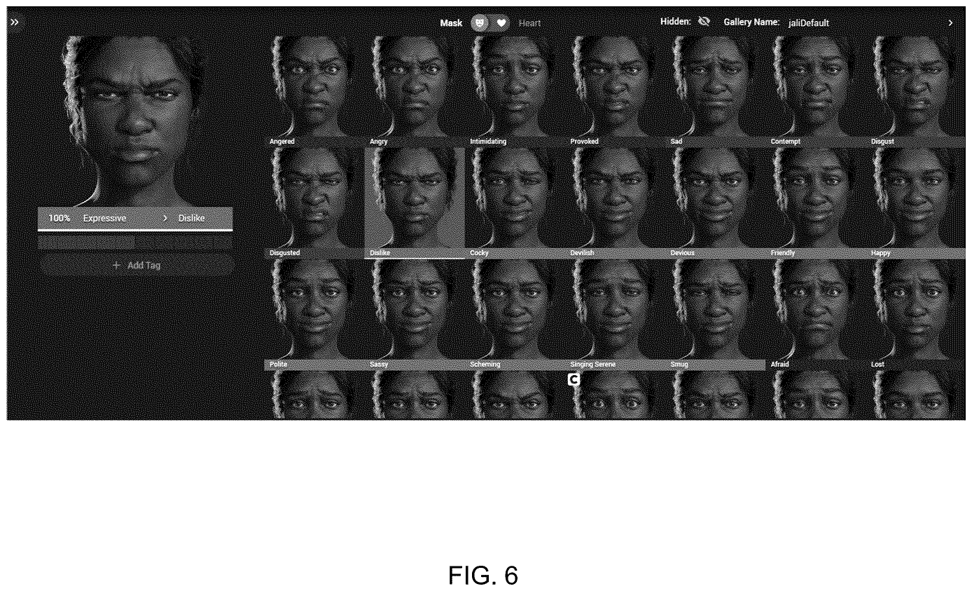

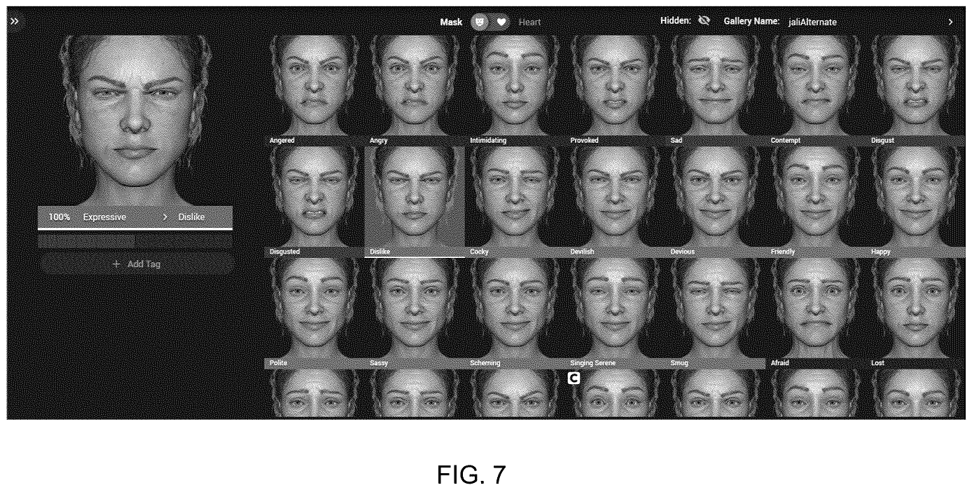

FIGS. 6 and 7 show two example views of the expression browser of the user interface showing many possible mask emotion bearings. The views show the output of the same expression on two respective output character rigs.

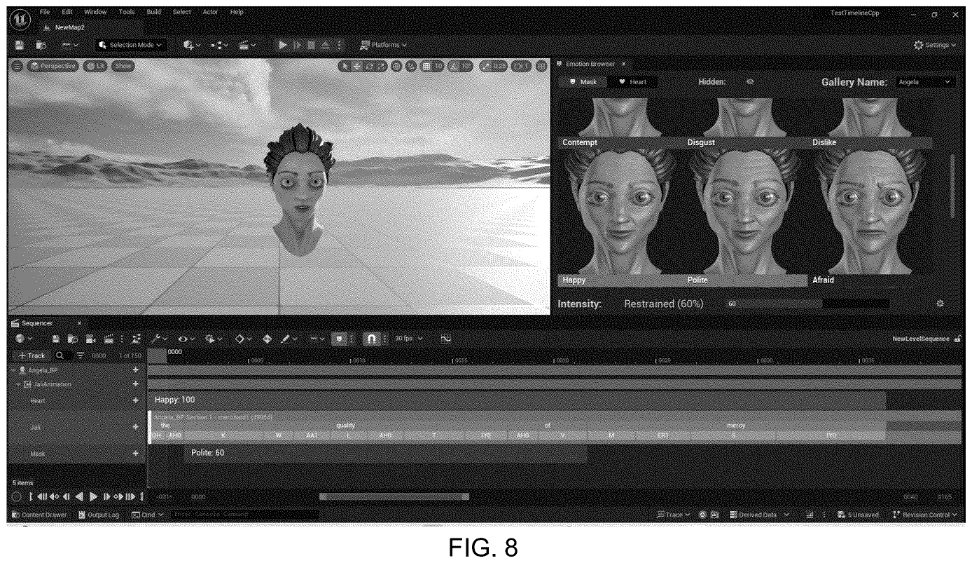

FIG. 8 shows an example screenshot of another approach for the expression browser and timeline interface inside an Unreal Engine™ plugin. Aligned phonemes are shown for an example sentence, along with two partially overlapping mask and heart expression tags, as tracks in the Unreal Engine™ editor sequencer. A set of possible mask expression bearings is visible in the upper right. In the preview window, a live preview of the output of the user-defined audio and text input and emotion tags is visible inside Unreal Engine™.

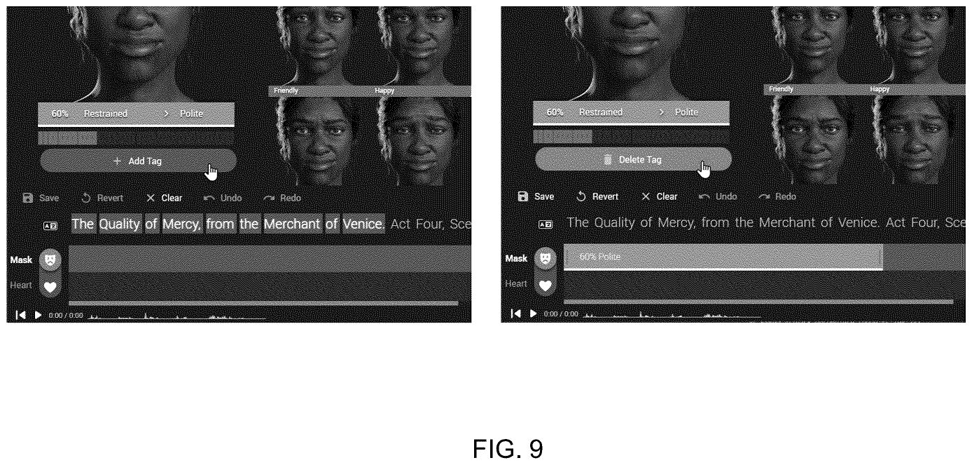

FIG. 9 shows an example of adding a tag via user input using the expression browser and timeline. After selecting a bearing and intensity for a mask tag (Bearing Polite, Intensity 60%), the user selects a set of words in the text transcript and adds a tag. In this case, this is performed by highlighting the words with a click and mouse-over action, and clicking an add tag button.

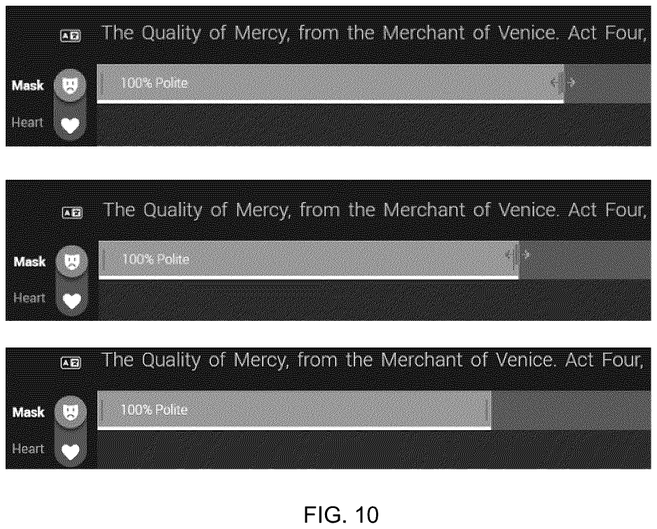

FIG. 10 shows an example of editing the section of the text transcript that a tag applies to via user input. In this case, a user clicks and drags the bounds of the tag and they automatically snap to a position on the timeline that defines the bounds of a valid tag. In the illustrated case, it is aligned with the word boundaries, but in other cases, this could be aligned with the phoneme boundaries.

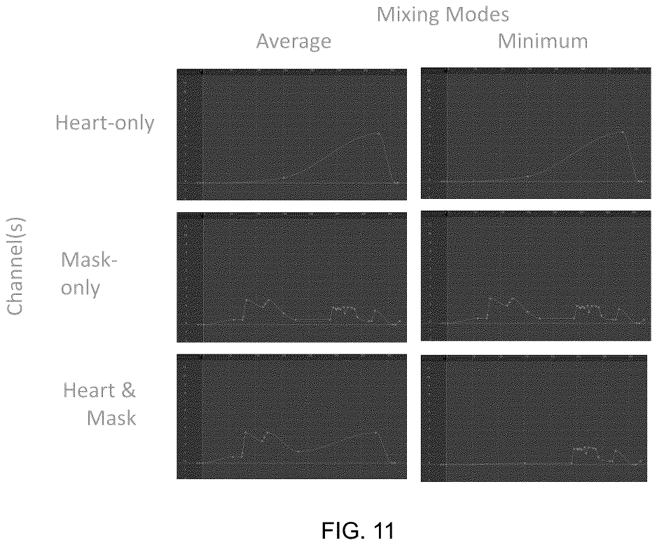

FIG. 11 illustrates an example of activation values of the “AU 01 Inner Brow Raise” for a case where there are overlapping heart and mask expressions. In the start of the spoken audio, from time=0 to time=160, the underlying mask activation is higher than the underlying heart activation, and at a later time, the underlying heart activation is higher. In the bottom row, where the two expression channels are combined, this results in the mask channel dominate up until time=160 and the heart channel dominates after that in the maximum mixing mode and the opposite behavior in the average mixing mode. Many more keyframes are inserted in regions where the mask channel is dominant. Because of the different mixing functions, the minimum mixing mode results in much lower overall activation values.

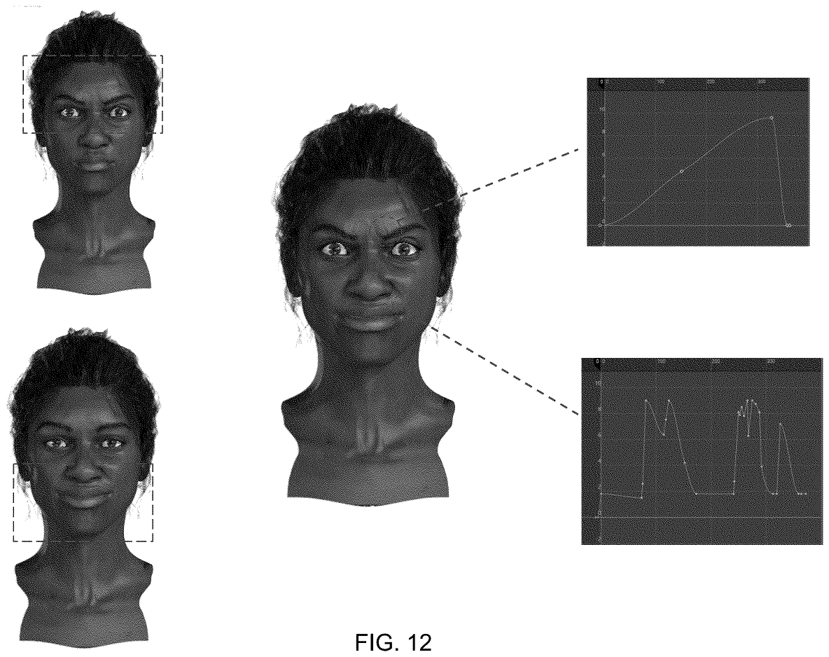

FIG. 12 illustrates an example of combining a mask channel expression and heart channel expression that overlap in time but do not overlap in space. In this case, the brows (like the representative AU 04 Brow Furrow L whose activation are shown) are driven completely by the custom heart expression “angry_eyes” which only affects the brow, while the lower face (like the representative AU 12 Smile L whose activation is shown) is only affected by the custom mask expression “smile_lower”. This creates the effect of an inauthentic smile that doesn't reach the eyes with angry furrowed brow—a person unsuccessfully trying to cover anger with a pleasant expression. Because the channels never affect the same action units, there is no mixing between expression channels, only mixing of mask expression on the lower face with speech when they affect the same AU.

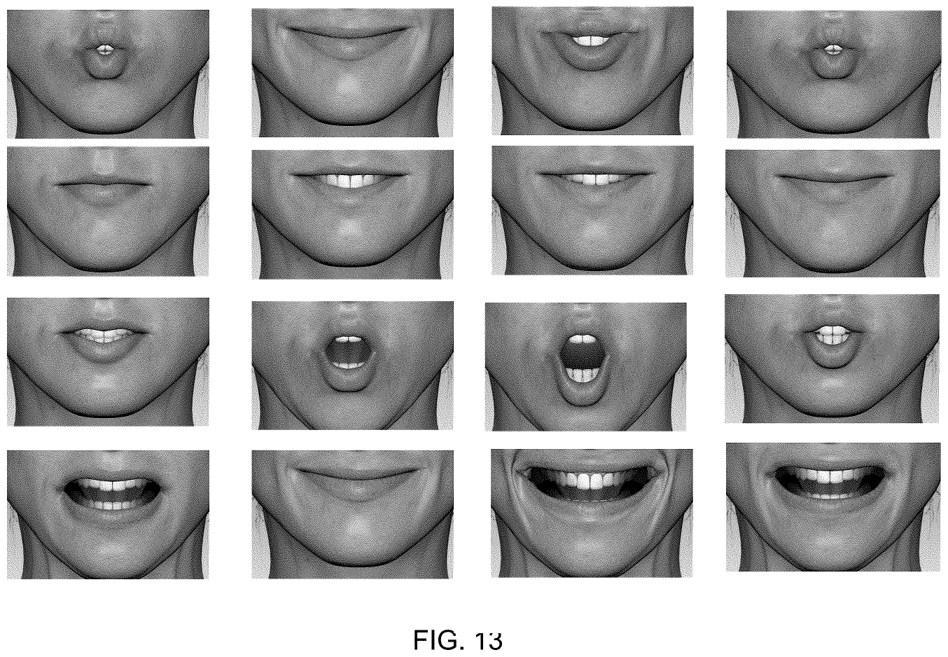

FIG. 13 illustrates an example of output character rig deformations showing the effect of constraints that prevent unrealistic face configurations when combining speech and expression curves. In each row, the combination looks more realistic in the final column, with the constraint applied to the combination.

The top row of FIG. 13 shows, from left to right, the phoneme “Uu” creating a pucker effect, a smile expression which triggers lip stretching, and the combination of those activation values without the “pucker kills lip stretch” constraint. This shows that the animated behavior is unrealistic. Also shown is the combination of these activation values with the “pucker kills lip stretch” constraint, illustrating that it is more realistic.

The second row of FIG. 13 shows, from left to right, the phoneme “Ma”, a grin expression which opens the lips, the combination of the phoneme and expression without the lipCloser constraint (showing unrealistic open lip pose when pronouncing the “Ma” phoneme), and the combination of the phoneme and expression with the lipCloser constraint.

The third row of FIG. 13 shows, from left to right, the phoneme “S”, the phoneme “O”, the combination of those two phonemes (showing unrealistic open jaw pose when pronouncing the “S” and “O” phonemes together), and the combination of the two phonemes with the jawCloser constraint.

The fourth row of FIG. 13 shows, from left to right, an “Ee” phoneme, a smile expression, the combination of the phoneme and the expression with EmotionOnSpeech blending set to additive (which causes an undesirable overdrive in the lipCornerPull AU, resulting in the smile blendshape going beyond its designed limit, causing the face to go off-model, and the polygons to break), and the combination of the phoneme and expressions with EmotionOnSpeech blending set to maximum.

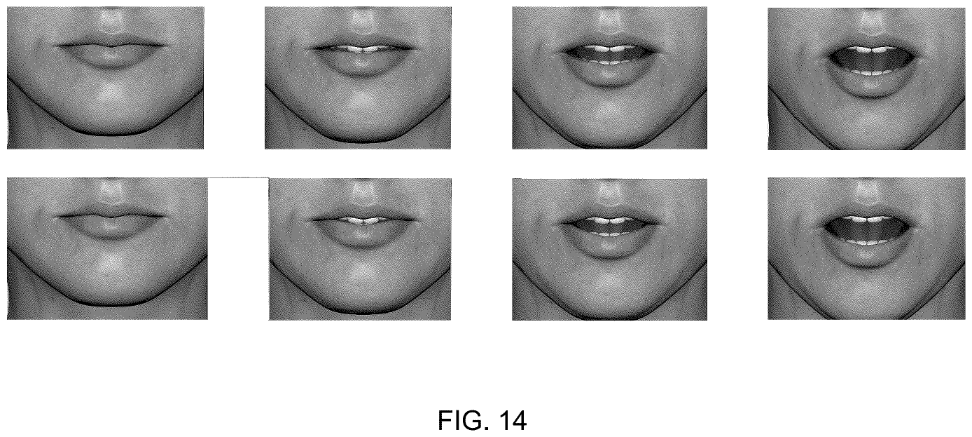

FIG. 14 shows example output character rig deformations showing the effect of the lip stick constraint. In each row, the jaw is deformed from 0% open on the first column, to 10% open in the second column, to 20% open in the third column, to 30% open in the fourth column. The top row shows this sequence of deformations with no lipstick constraint, while the bottom shows the sequence of deformations with the lipstick constraint. There is no difference between the two rows when the jaw is fully closed (first column), or open by 30% or more (last column) but in the middle two columns, representing the jaw being open by a small amount (which can be caused by expression curves, speech curves, or a combination of the two), the corners of the lips show a more physically realistic behavior when the lipstick constraint is applied and the corners of the lips remain close together.

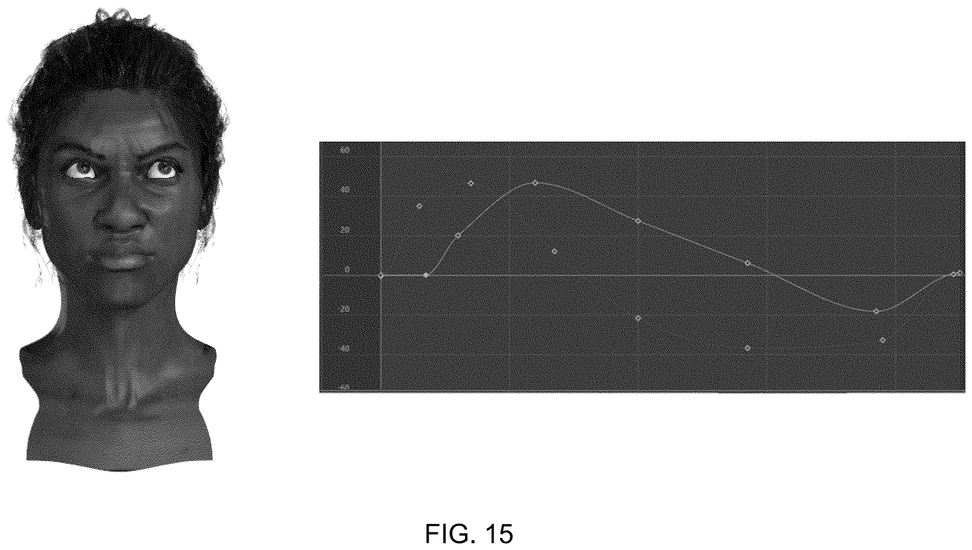

FIG. 15 illustrates an example of a non-static expression (an eye-roll) which cannot be described in terms of a single expression pose. The two deformers (representing the x and y spatial position's of the character's look at point) need to move in synchronized motion to create the eye-roll expression. The apex of the eye-roll can be positioned in time to match a high arousal level to coordinate it with expressions on the heart or mask channels.

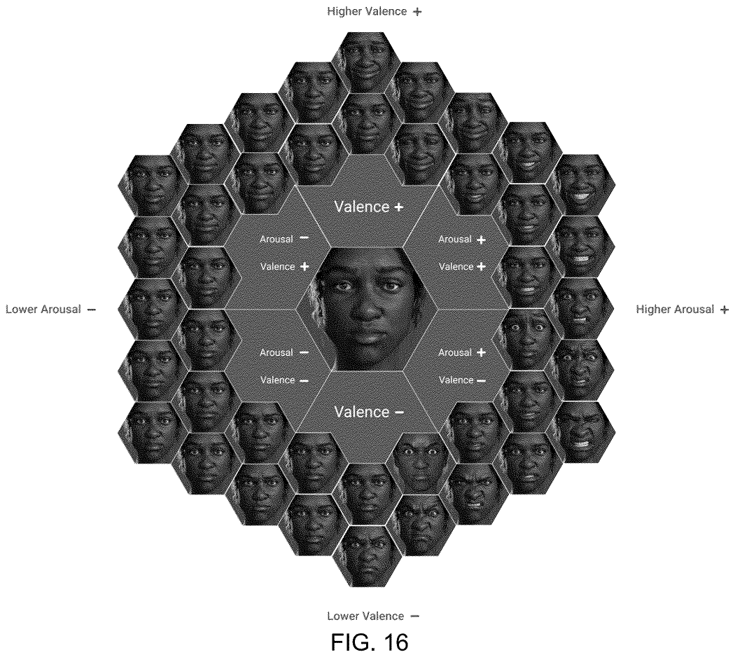

FIG. 16 illustrates a form of the expression browser of the user interface where the expressions are sorted by valence and arousal around the currently selected expression. Valence increases towards the top of the layout and decreases towards the bottom of the layout. Arousal decreases towards the left of the layout and increases towards the right of the layout.

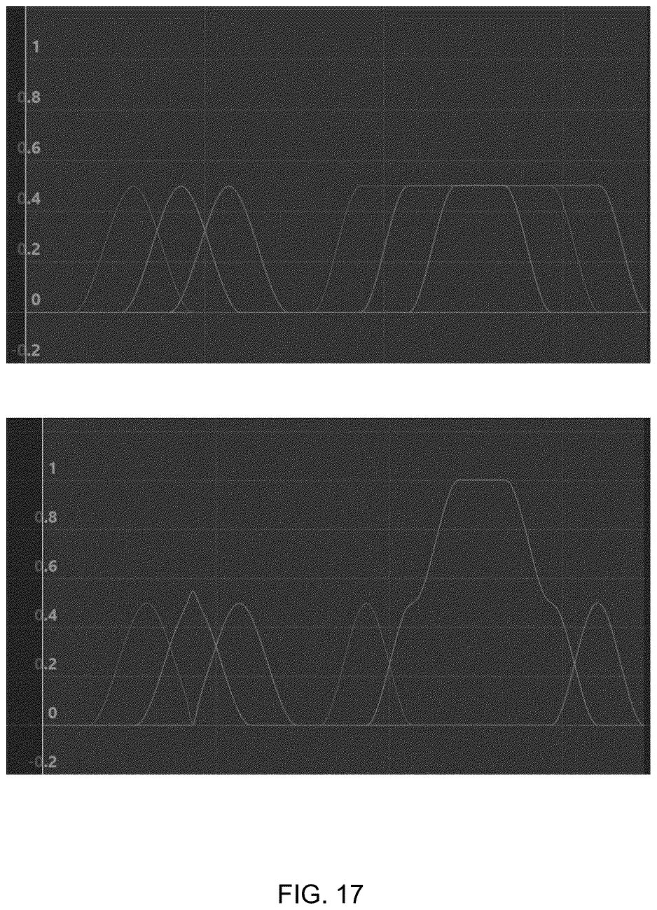

FIG. 17 illustrates a realistic example of input and output of additive balancing on a smile AU. Two of the curves are the left/right controls of the action unit, while the other curve is the symmetric control. After additive balancing is performed, some of the magnitude of the left/right controls is placed on the central control, and the magnitude of the left/right controls is decreased. The two sets of curves produce the same effect on the output character rig.

The combination of the two or more channels, as described herein, allows for great realism in combinations of emotions. For example, often times a person will want to project an outwardly facing emotion as a social mask, which is captured in the mask channel, and represents high twitch, fast movements. However, how the person actually feels, captured in the heart channel, tends to seep through with low frequency movements, in what can be referred to as ‘leakage’. The present embodiments are advantageously able to display such leakage in a realistic and believable fashion.

While the present disclosure generally describes activation values acting on action units, such as in FACS, it should be understood that any suitable facial parameters, blend shapes, and/or deformers (or collections of deformers) of the face can be used; for example, facial parameters that are more or less populated, or situated differently, on the face than the action units in FACS. In this way, the facial parameters can be deformed by blend shapes, be deformed by bone location and relative movement, or deformed by any other suitable technique.

Additionally, while the present disclosure generally describes face movements in response to dialogue or received spoken signals, it should be understood by a person skilled in the art that combining of expression channels, as taught herein, can be used in any suitable circumstances, such as where a character is merely reacting and there is no speech or audio signal present.

The present embodiments can have a number of potential applications in the realm of computer animation; such as use for generating media and video games. Other applications may become apparent.

Although the invention has been described with reference to certain specific embodiments, various modifications thereof will be apparent to those skilled in the art without departing from the spirit and scope of the invention as outlined in the claims appended hereto.

1. A method of combining expressive facial behavior for an animated character, the method executed on a processing unit, the method comprising:
receiving two or more expressions to be expressed on the animated character, the expressions comprise activation values for one or more facial parameters on the animated character and temporal keyframes for such activation values, at least two of the two or more expressions overlap for a given period of time;
assigning each of the two or more expressions to a respective channel, one of such channels being designated as dominant;
combining the activation values of the expressions from the two or more channels for each of the one or more facial parameters, the expression in the dominant channel designating the temporal keyframes when the activation values of the two or more expressions are combined; and
outputting the combined activation values for animation of the animated character.

2. The method of claim 1, wherein each received expression is associated with a received duration for such expression, and wherein at least a portion of the duration of two of the expressions overlap in time.

3. The method of claim 2, wherein the expressions are aligned with a transcript or audio, and wherein at least a portion of the overlap is for the duration of a phoneme or sub-phoneme in the transcript or audio.

4. The method of claim 1, wherein the activation values of the one or more channels that are not dominant are residual activation values, the residual activation values are constant for a given temporal duration.

5. The method of claim 1, wherein the activation values from the channels are combined using one of maximum, minimum, average, sum, sum-max, and max-blend operators.

6. The method of claim 1, wherein the activation values are combined using a maximum function whereby the activation values from one of the non-dominant channels is expressed when greater than the activation value of the dominant channel.

7. The method of claim 1, further comprising constraining the combined activation values at a particular facial parameter to a threshold value.

8. The method of claim 7, wherein constraining the combined activation values is based on constraining facial parameter shapes for producing speech.

9. The method of claim 1, wherein the two or more expressions are received from a user interface that can receive selections from the user, the user interface presents a gallery of expressions to the user with a range of intensity values.

10. The method of claim 1, wherein symmetrical action units on both sides of the face are constrained to be activated similarly.

11. A system for combining expressive facial behavior for an animated character, the system comprising a processing unit and a data storage, the data storage comprising instructions for the processing unit to execute:
an input module to receive two or more expressions to be expressed on the animated character, the expressions comprise activation values for one or more facial parameters on the animated character and temporal keyframes for such activation values, at least two of the two or more expressions overlap for a given period of time;
an expression module to assign each of the two or more expressions to a respective channel, one of such channels being designated as dominant;
an activation module to combine the activation values of the expressions from the two or more channels for each of the one or more facial parameters, the expression in the dominant channel designating the temporal keyframes when the activation values of the two or more expressions are combined; and
an output module to output the combined activation values for animation of the animated character.

12. The system of claim 11, wherein each received expression is associated with a received duration for such expression, and wherein at least a portion of the duration of two of the expressions overlap in time.

13. The system of claim 12, wherein the expressions are aligned with a transcript or audio, and wherein at least a portion of the overlap is for the duration of a phoneme or sub-phoneme in the transcript or audio.

14. The system of claim 11, wherein the activation values of the one or more channels that are not dominant are residual activation values, the residual activation values are constant for a given temporal duration.

15. The system of claim 11, wherein the activation values from the channels are combined using one of maximum, minimum, average, sum, sum-max, and max-blend operators.

16. The system of claim 11, wherein the activation values are combined using a maximum function whereby the activation values from one of the non-dominant channels is expressed when greater than the activation value of the dominant channel.

17. The system of claim 11, the processing unit further executes a constraint module to constrain the combined activation values at a particular facial parameter to a threshold value.

18. The system of claim 17, wherein constraining the combined activation values is based on constraining facial parameter shapes for producing speech.

19. The system of claim 11, wherein the two or more expressions are received from a user interface that can receive selections from the user, the user interface presents a gallery of expressions to the user with a range of intensity values.

20. The system of claim 11, the processing unit further executes a constraint module to constrain symmetrical action units on both sides of the face to be activated similarly.
